(19) United States
(12) Patent Application Publication
(10) Pub. No.: US 2014/0331553 A1
(43) Pub. Date: Nov. 13, 2014

(54) PLANT HYDRATION METHOD AND COMPOSITION

(71) Applicant: Luther Vernon Owens, Hemmingway, SC (US)

(72) Inventor: Luther Vernon Owens, Hemmingway, SC (US)

(21) Appl. No.: 14/275,917

(22) Filed: May 13, 2014

Related U.S. Application Data
(60) Provisional application No. 61/822,733, filed on May 13, 2013.
(60) Provisional application No. 61/924,421, filed on Jan. 7, 2014.

(51) Int. Cl. A01C 1/06

(52) U.S. Cl. CPC A01C 1/06
USPC 47/57.6

(57) ABSTRACT

A composition comprising super absorbent polymers, such as polyacrylates, combined with other materials, and provided to the seed at the time of planting in the soil, or shortly thereafter, provides hydration to the seed for proper germination of the seed. The composition is effective to provide hydration for an extended period when placed or injected underground adjacent to the seed, even if no rainfall is experienced. The material supports and aids uniform germination of multiple, plants, such as plants in an agricultural field.

### FIELD OF THE INVENTION

This invention relates to agriculture horticulture generally, and is more specifically related to a method and composition for hydrating and providing nutrients to plants.

### BACKGROUND OF THE INVENTION

Plants need water for germination and growth. When seeds are planted, the first few weeks of a plant's life are critical. If seeds are planted in soil, and adequate hydration of the soil is not present and maintained, the seeds either may not germinate, or if the seeds germinate, proper growth of the plant will be impaired. In many cases, such impairment is permanent.

Rainfall is unpredictable. For example, much of the corn crop in the agricultural regions of the mid-western United States has failed or provided low yields due to drought conditions over the past few years. Other crops, such as soybeans and wheat, were also materially impacted by drought.

As the demand for water increases due to population growth and other reasons, less water is available for irrigation. This fact, combined with a recent trend toward lower rainfall in many parts of the world, indicates a need for devices, methods and compositions that can facilitate seed germination and plant growth.

### SUMMARY OF THE INVENTION

A composition comprising super absorbent polymer is combined with other materials and provided to a seed at the time of planting the seed in soil, or thereafter provided to a root system of a plant. The composition provides hydration to the seed for proper germination of the seed. The composition effectively provides hydration for approximately three (3) to five (5) weeks, depending on soil and weather conditions, when placed or injected underground and adjacent to or surrounding the seed, even if no rainfall is experienced. Accordingly, the composition and method provide hydration to the plant during the critical period of germination and initial growth of the plant. The composition supports uniform germination of multiple plants, such as plants in an agricultural field.

### BRIEF DRAWING DESCRIPTION

FIGS. 1A through 1D demonstrate progression of development of a seed from planting (FIG. 1A) through complete germination of the seed to a plant (FIG. 1D).

FIGS. 2A and 2B demonstrate planting a seed within a composition comprising super absorbent polymer.

### PREFERRED EMBODIMENTS OF THE INVENTION

The present invention is a composition comprising super absorbent polymer, such as polyacrylates, combined with other materials, and provided to a seed at the time of planting in the soil, or shortly thereafter. The composition provides hydration to the seed for proper germination of the seed. The composition effectively provides hydration for approximately three (3) to five (5) weeks, depending on soil and weather conditions, when the composition is placed or injected underground and adjacent to the seed, even if no rainfall is experienced. Accordingly, the composition and method provide hydration to the plant during the critical period of germination and initial growth of the plant. The composition supports uniform germination of multiple plants, such as plants in an agricultural field.

Further, the composition and method may be used for plants after germination and after the plant is above ground. Just as the composition is supplied with seeds at the time of planting, the composition is injected into the soil, and is present below the surface of the soil. The composition is preferably injected into the root system very soon after germination, so that hydration is available to the root system.

The preferred primary ingredient is a super absorbent polymer such as polyacrylate. The superabsorbent polymer may be Luquasorb® or other brands of the super absorbent polymer. Potassium polyacrylate, which may be in powder form, may be used. Potassium based super absorbent polyacrylates are greatly preferred by the inventor over starch based super absorbent polymers that have been used by others. The hydrophilic superabsorbent polymer is activated by water absorption prior to injecting the composition into the soil. The composition may be placed into the soil substantially contemporaneously with planting of the seed, or later, within the root system of the plant, or both.

In one embodiment, the composition comprises, by volume:

| | |
|---|---|
| Luquasorb 1280 | 1-3% |
| Water | 94-99% |
| Sucrose (sugar) | 0.5-3% |

The water is preferred to be sufficiently pure so as to have a substantially neutral pH. Other disaccharides and monosaccharaides, such as glucose and fructose, may be used in comparable percentages.

Additional materials may be added to enhance the performance of the composition. For example, the composition may further comprise fertilizers or other plant nutrients that are known to promote plant growth, used as directed by the manufacturer, or added at a rate of 1-2% of the composition by volume. Enzymes that work at a genetic level, such as mn-superoxide dismutase, catalase (CATS), dehydroascorbate reductase (DHR), and/or thioredoxin reductase (THR) may be used. A formulation sold as Bio-Forge® by Stoller may be added to the composition. The additional materials are dissolved in the water and distributed, such as by stirring. A non-toxic colorant, such as a green color, may also be dissolved and distributed in the water. The super absorbent polymer, such as Luquasorb, is then added and the composition is thereafter thoroughly mixed, such as by stirring or agitating.

Plant hormones mixed with the hydrated polyacrylate have been found to be particularly useful. Examples are of preferred hormones that may be used with the hydrated polyacrylate are auxins (IAA), cytokinin (CYK), ethylene (ETH), gibberellic acid (GA) and abscisic acid (ABA). These hormones may be sourced from Stoller Enterprises, Inc. The use of the hormones mixed with the hydrated polyacrylate and applied as taught herein has led to unexpected results in crop yields.

Use of the hydrated polyacrylate allows the hormone combination to be applied to the seed as it is planted, even though some of the hormones are more useful for germination, and some are more useful for plant growth. The hydrated polyacrylate holds the hormones in close proximity to the root system, and retards absorption of the hormones into the soil. Accordingly, the hormone combination is available to the plant after germination and as the plant develops a root system, even thought the hormone combination is applied at the time of planting the seed.

When the super absorbent polymer is mixed with water, the resulting material is highly viscous. When injected into soil, the composition provides hydration to the adjacent seed and/or plant root system for an extended period. Similarly, the additional materials, such as enzymes or other materials that are dissolved in the water are provided to the root system of the plant.

According to the present invention, the super absorbent polymer, which may be a dry polyacrylate, such as potassium polyacrylate, is added to still, or substantially still, water. That is, the super absorbent polymer is added to the still or substantially still water and is not agitated during the process of combining the super absorbent polymer with water. This method of absorption of the water by the super absorbent polymer has been found to be material to obtaining desired results. The water should not be added to the super absorbent polymer, but rather, the super absorbent polymer added to the water. Only after this activation process is complete or substantially complete, should the combination of super absorbent polymer and water be agitated.

In one embodiment, dry potassium polyacrylate is added to still water at a ratio of 0.010 to 0.015 kilograms per liter. The non-agitated combination is allowed to sit for about 5 to 15 minutes. The resulting composition is more viscous than water, but is sprayable with common spraying devices used in agriculture.

Materials as desired are mixed with the composition as desired. For example, an equal mixture of auxins (IAA), cytokinin (CYK), and gibberellic acid (GA) may be added to the composition at a ratio of 6 to 10 ml per liter, or distributed with the composition at a rate of about 0.1 to 0.25 liters per acre.

Dry flowable fertilizers, including high nitrogen fertilizers such as 24-8-16, may be added to the composition. Liquid nitrogen has not been found to be useful with the composition. Inoculants that are used with plants such as peanuts and legumes may be added to the composition. Fungicides and/or insecticides that are used in agriculture or horticulture may be added to the composition.

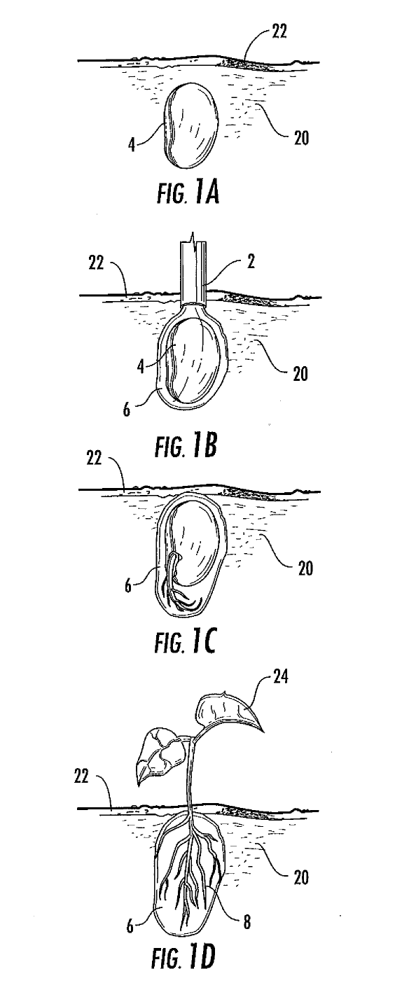

The super absorbent polymer composition prepared as described is injected below the top surface 22 of the soil 20, and is present adjacent to the seed or root system, so that the composition provides hydration and feeds the plant. FIG. 1. In one embodiment, an injector 2 having a nozzle or outlet that is positioned below the soil level dispenses about 5 to 15 milliliters of the composition 6 adjacent to, and preferably completely surrounding, seed 4. FIG. 1B. By injecting the composition under the surface of the soil to a depth that retards evaporation from exposure of the composition to the atmosphere above the soil, the water in the composition is preserved, and is not subject to rapid evaporation. Further, the relatively high viscosity of the composition prevents rapid absorption or dissipation of the composition into the soil. While FIG. 1B demonstrates injecting the composition around a seed that is covered with soil, the composition may be injected prior to covering the seed with soil, as long as the composition and seed are covered with soil very soon after the composition is injected.

As shown in FIG. 1C, the composition stays in contact with the root system 8 after germination to continue to provide hydration to the plant 24. The plant is fed and hydrated for an extended period. In a typical application, with the composition placed 5 centimeters (2 inches) or more below the surface of the soil, the composition will remain as a useful liquid for plant hydration for several weeks without subsequent hydration, depending on soil and humidity conditions. The composition provides hydration for the root system of the plant after complete germination of the plant 24. FIG. 1D.

Longevity of the presence of water in the composition is improved by the depth of the material below the surface of the soil. Water will be retained within the composition and available to the plant for a longer time period when the composition is placed 10 centimeters below the surface of the soil than when the composition is 5 centimeters below the surface of the soil. The composition is preferred to be placed below the soil at a depth that will yield 25% water retention in the composition three (3) weeks after placement of the composition into the soil. Soil composition and humidity also factor into water retention by the composition.

While the super absorbent polymer composition is more viscous than water, it is sufficiently flowable to be capable of injection or application by mechanical means, such as spray devices or liquid injection devices. Seed planters as used in agricultural operations may be adapted to inject the composition at the exact location of the seed. The seed and the composition may be positioned by the planter at substantially the same time and substantially the same place so that the composition is in contact with the seed, and ultimately, with the root system of the plant.

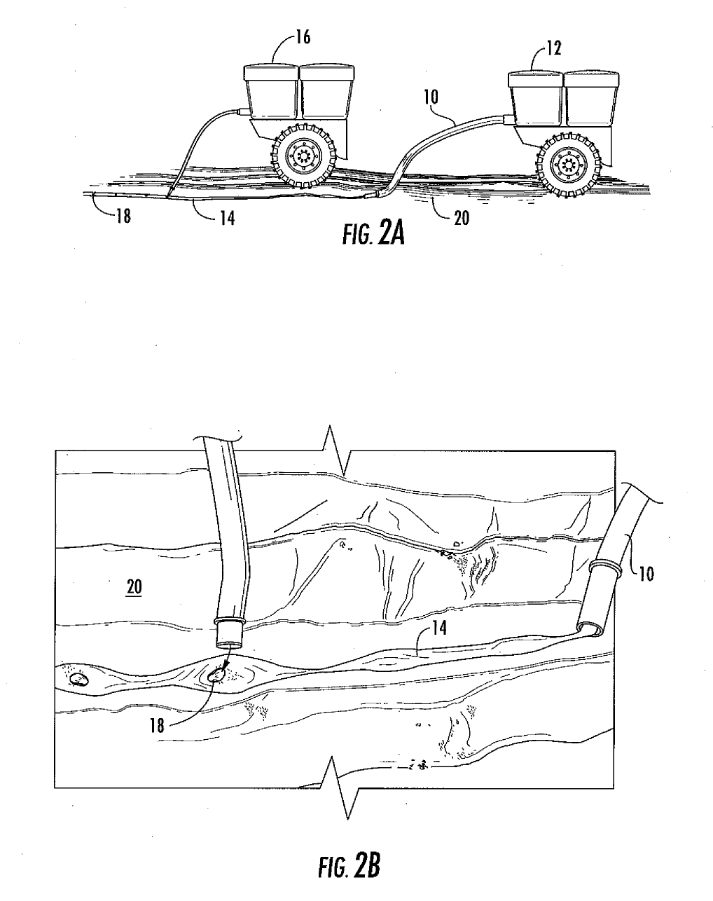

In one embodiment, a conduit 10 from a tank 12 lays down a bead of the super absorbent polymer composition 14 in a furrow formed for planting during the planting operation. FIG. 2. The seed 18 is then planted, such as by a planter 16, with the seed placed into the composition 14. The seed and the composition are then covered with soil to a desired depth. By laying down a bead of the composition, it is only necessary to open a valve at the beginning of the operation, and close the valve to the tank at the end of the operation. In a preferred embodiment, the flow of the material during the planting operation will be at a rate of not less than 75 liters of the composition per acre. Mechanical seed planters currently in use that simultaneously plant multiple rows of seeds may be used, and such planters may be adapted to place the composition 14 in the furrow at the proper depth and location of the seed to be planted.

The super absorbent polymer composition and method may be used in farming to facilitate germination and growth of crops, as well as in tree farming and by nurseries. When used in tree farming or nursery operations, or in small farming operations, a device that pierces the top of the soil and dispenses the composition into the root system may be used. The operator can position a wand or similar device to place the composition into the root system and below the top surface of the soil.

The super absorbent polymer composition promotes uniform germination of the plant system, such as multiple seeds planted at the same time. The composition provides improved drought resistance when used according to the method described. The material concentrates water and, if used, hormones and nutrients at the plant root system for an extended period of time. Therefore, fertilizers are available to the roots for an extended period of time. The super absorbent polymer, such as polyacrylate, rehydrates (reactivate) by absorbing water during subsequent rain events or during irrigation, and holds water at the root system, rather than the water being fully absorbed by the soil. Irrigation frequency, and therefore the amount of water used, and the amount of fertilizer and hormones used, may be reduced by use of the invention.

The composition prepared according to the invention and used according to the method of the invention avoids water runoff and evaporation experienced with other irrigation systems. The composition provides hydration, and optionally, nutrients directly to the root system. The composition and method produce consistent root characteristics in a field of the same plant variety, resulting in higher yields. The composition and method produce higher germination rates when placed with seed than planting without the composition according to the method. The composition is compatible with treated seeds.

What is claimed:

1. A method of plant hydration, comprising the steps of:
preparing a composition comprising a potassium based hydrophilic super absorbent polymer and not less than 90% water by volume;
placing the composition in soil and in contact with a plant seed that is within the soil;
wherein the composition and the plant seed are below a top surface of the soil and are covered by the soil.

2. The method of plant hydration according to claim 1, wherein the step of preparing the composition further comprises adding a saccharide to the composition.

3. The method of plant hydration according to claim 1, wherein the step of preparing the composition comprises the step of placing the hydrophilic super absorbent polymer into substantially still water, and materially agitating the water and hydrophilic super absorbent polymer only after placement of the hydrophilic super absorbent polymer into the still water is substantially complete.

4. The method of plant hydration according to claim 1, wherein the composition is placed in the soil to surround the plant seed.

5. The method of plant hydration according to claim 1, wherein a step of planting the plant seed occurs prior to the step of placing the composition in the soil.

6. The method of plant hydration according to claim 1, wherein a step of planting the plant seed occurs prior to the step of placing the composition in the soil and the plant seed is covered by soil prior to placing the composition in the soil.

7. The method of plant hydration according to claim 1, wherein the step of placing the composition in the soil occurs prior to a step of planting the plant seed.

8. The method of plant hydration according to claim 1, further comprising the steps of placing a bead of the composition in furrows formed in the soil placing a plurality of plant seeds sequentially into the bead of the composition along a length of the bead of the composition, and covering the bead of the composition and the plurality of plant seeds with the soil.

9. The method of plant hydration according to claim 1, wherein the hydrophilic super absorbent polymer comprises potassium polyacrylate.

10. The method of plant hydration according to claim 1, wherein the composition comprises an enzyme that promotes plant growth.

11. The method of plant hydration according to claim 1, wherein the composition comprises a hormone that promotes plant growth.

12. The method of plant hydration according to claim 1, wherein the composition comprises a hormone that promotes plant seed germination.

13. The method of plant hydration according to claim 1, wherein the composition comprises a first hormone that promotes plant germination and a second hormone that promotes plant growth.

14. The method of plant hydration according to claim 1, wherein at least 25% of the water is present in the composition three (3) weeks after placing the composition in contact with the plant seed.

15. The method of plant hydration according to claim 1, wherein the composition comprises fertilizer.

16. The method of plant hydration according to claim 1, wherein the composition comprises an enzyme that promotes plant growth and fertilizer.

17. The method of plant hydration according to claim 1, wherein the composition comprises an inoculant.

18. The method of plant hydration according to claim 1, wherein the composition and the plant seed are below a top surface of the soil at a depth of at least 5 centimeters.

19. The method of plant hydration according to claim 1, wherein the step of preparing the composition further comprises adding a saccharide to the composition, and wherein the saccharide is chosen from a group consisting of monosaccharaides and disaccharides.
